(19) United States
(12) Patent Application Publication
(10) Pub. No.: US 2024/0363923 A1
(43) Pub. Date: Oct. 31, 2024

(54) COOLING DEVICE FOR VEHICLE BATTERY MODULE

(71) Applicant: TOYOTA JIDOSHA KABUSHIKI KAISHA, Toyota-shi Aichi-ken (JP)

(72) Inventor: Katsuyuki HOJO, Toyota-shi Aichi-ken (JP)

(73) Assignee: TOYOTA JIDOSHA KABUSHIKI KAISHA, Toyota-shi Aichi-ken (JP)

(21) Appl. No.: 18/631,841

(22) Filed: Apr. 10, 2024

(30) Foreign Application Priority Data
Apr. 28, 2023 (JP) 2023-075181

(51) Int. Cl. H01M 10/6568; B60L 50/64; H01M 10/613; H01M 10/625; H01M 50/209; H01M 50/507

(52) U.S. Cl. CPC H01M 10/6568; H01M 10/613; H01M 10/625; H01M 50/209; H01M 50/507; B60L 50/64; H01M 2220/20

(57) ABSTRACT

A cooling device for cooling a vehicle battery module that includes (i) a plurality of battery cells arranged in a predetermined direction and (ii) a bus bar electrically connecting between external electrodes of each adjacent two of the battery cells. The cooling device includes: a cooling pipe portion configured to guide a cooling liquid onto the battery module such that at least a portion of the bus bar and the cooling liquid are in thermal contact with each other; and a battery cooling circuit configured to cool the bus bar, by circulating the cooling liquid between the cooling pipe portion and a cooler.

### CROSS-REFERENCE TO RELATED APPLICATION

This application claims priority from Japanese Patent Application No. 2023-075181 filed on Apr. 28, 2023, the disclosure of which is herein incorporated by reference in its entirety.

### TECHNICAL FIELD

The present disclosure relates to a cooling device for effectively cooling a vehicle battery module in which a plurality of battery cells are arranged.

### BACKGROUND

There is proposed a cooling device for effectively cooling a vehicle battery module in which a plurality of battery cells are arranged to be adjacent to each other in a predetermined direction. For example, a cooling device for a battery module disclosed in Patent Document 1 is such a cooling device.

The cooling device disclosed in Patent Document 1 includes: a heat conduction member mounted on an upper surface of the battery module and having a medium flow path formed therein; a plurality of cooling fins having upper end portions connected to the heat conduction member and disposed on side surfaces of the battery cells; a pair of main pipes disposed on opposite sides of the battery module and arranged in parallel to the direction in which the battery cells are arranged; and a branch pipe connecting between the pair of main pipes and the medium flow path formed in the heat conduction member. Thus, upper surfaces of the battery cells, which are in contact with the heat conductive member, and the side surfaces of the battery cells, which are in contact with the cooling fins, are cooled.

### PRIOR ART DOCUMENT

### Patent Document

### Patent Document 1

Japanese Patent Application Laid-Open No. 2014-509441

### SUMMARY

In general, when the battery module is used under a high load, heat is generated between a current collector and inner side portions of the battery cells of external electrodes connected to bus bars, in proportion to square of current. Therefore, cooling is desired in order to suppress deterioration of the battery module.

However, in the cooling device for the battery module disclosed in Patent Document 1, since the cooling device has a structure for cooling the battery cells by the heat conduction member and the cooling fin which are disposed outside of the battery cells, the heat conduction member and the cooling fin are distant from a heat generation portion in each battery cell, and thus thermal resistance is high. Therefore, there is a problem that cooling cannot be efficiently performed.

The present disclosure has been made in view of the above circumstances, and an object of the present disclosure is to provide a cooling device for cooling a vehicle battery module with a high cooling efficiency.

The present disclosure provides a cooling device for cooling a vehicle battery module that includes (i) a plurality of battery cells arranged in a predetermined direction and (ii) a bus bar electrically connecting between external electrodes of each adjacent two of the battery cells. The cooling device includes: (a) a cooling pipe portion configured to guide a cooling liquid onto the battery module such that at least a portion of the bus bar and the cooling liquid are in thermal contact with each other; and (b) a battery cooling circuit configured to cool the bus bar, by circulating the cooling liquid between the cooling pipe portion and a cooler.

According to the cooling device of the present disclosure, the cooling pipe portion is configured to guide the cooling liquid onto the battery module such that at least a portion of the bus bar and the cooling liquid are in thermal contact with each other. As a result, a junction between a portion of the external electrode connected to the bus bar on an inner side of the battery cell and a current collector is efficiently cooled, and thus high cooling efficiency is obtained.

In some embodiments, the cooling liquid is composed of an oil or an ion-exchanged water having an electric conductivity reduced by an ion-exchange membrane. Since the oil or the ion-exchanged water is a liquid having high insulation, even if liquid leakage occurs in the cooling pipe portion, electric leakage does not occur, and safety is enhanced.

In some embodiments, the cooling pipe portion covers a side surface of the bus bar and brings the cooling liquid into direct contact with the side surface of the bus bar. Thus, the cooling liquid is brought into direct contact with the side surface of the bus bar, so that the junction between the portion of the external electrode connected to the bus bar on the inner side of the battery cell and the current collector is efficiently cooled.

In some embodiments, the cooling pipe portion is a flat pipe disposed around the bus bar. Therefore, the cooling pipe portion is the flat pipe covering the side surface of the bus bar, and thus there is an aspect that a height of the battery module is not increased.

In some embodiments, the cooling pipe portion has a pipe wall having an electrical insulation property. This maintains insulation between the bus bars on the battery module, and enhances safety.

In some embodiments, the pipe wall having the electrical insulation property is a flexible sheet made of a resin layer, or a laminated sheet including a plurality of kinds of layers that include the resin layer. Thus, the pipe wall of the cooling pipe portion has electrical insulation, and therefore not only the electrical insulation between the bus bars is secured, but also the adhesion to the bus bars is enhanced because of the flexibility.

In some embodiments, the cooling pipe portion has a width dimension substantially the same as a dimension of each of the battery cells that is measured in a direction orthogonal to the predetermined direction in which the battery cells arranged, and is disposed on a surface of the battery cells on which the bus bar is provided. Thus, the cooling pipe portion is a flat pipe having the width dimension substantially the same as a width direction of the battery module, and therefore the battery module is made compact in size.

Further, since the battery cooling circuit is provided to cool the bus bar, by circulating the cooling liquid between the cooling pipe portion and the cooler. Thus, the battery cooling circuit circulates the cooling liquid between the cooling pipe portion and the cooler, thereby cooling the bus bar.

### BRIEF DESCRIPTION OF THE DRAWINGS

FIG. 1 is a perspective view for explaining a vehicle battery module to which the present disclosure is applied;

FIG. 2 is a perspective view for explaining an internal structure of one of a plurality of battery cells constituting the battery module of FIG. 1, with a side wall of a casing being removed;

FIG. 3 is a cross sectional view for explaining a structure of a laminated current collector in the battery cell of FIG. 2, by showing a main part of the laminated current collector in an enlarged manner;

FIG. 4 is a cross sectional view for explaining a construction of a cooling pipe portion on the battery module of FIG. 1, by showing a main part of the cooling pipe portion; and

FIG. 5 is a view for explaining an example of a cooling circuit for circulating a cooling liquid for cooling the battery module of FIG. 1.

### DETAILED DESCRIPTION OF EMBODIMENT

Hereinafter, an embodiment of the present disclosure will be described in detail with reference to the drawings.

### Embodiment

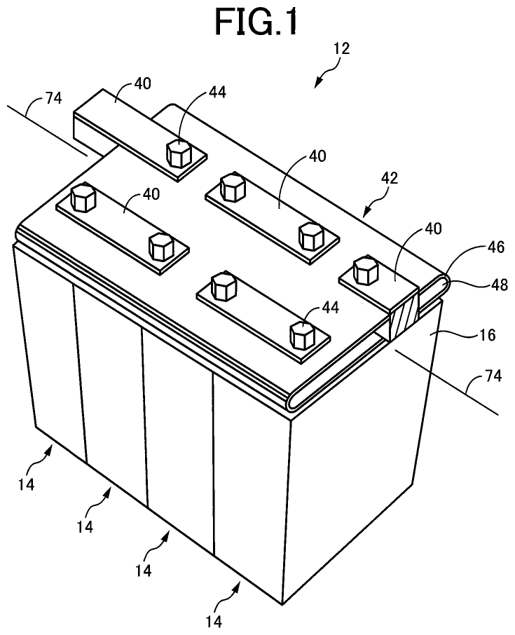

FIG. 1 is a perspective view showing a battery module 12 to which a cooling device 10 of the present disclosure is applied. The battery module 12 is to be used in a vehicle that uses an electric motor as a drive source, such as an electric vehicle, a hybrid electric vehicle or a plug-in hybrid vehicle. In FIG. 1, the battery module 12 includes a plurality of battery cells 14 (four battery cells 14 in the present embodiment) arranged to be adjacent to each other in a predetermined direction 74 that corresponds to a thickness direction of each of the battery cells 14.

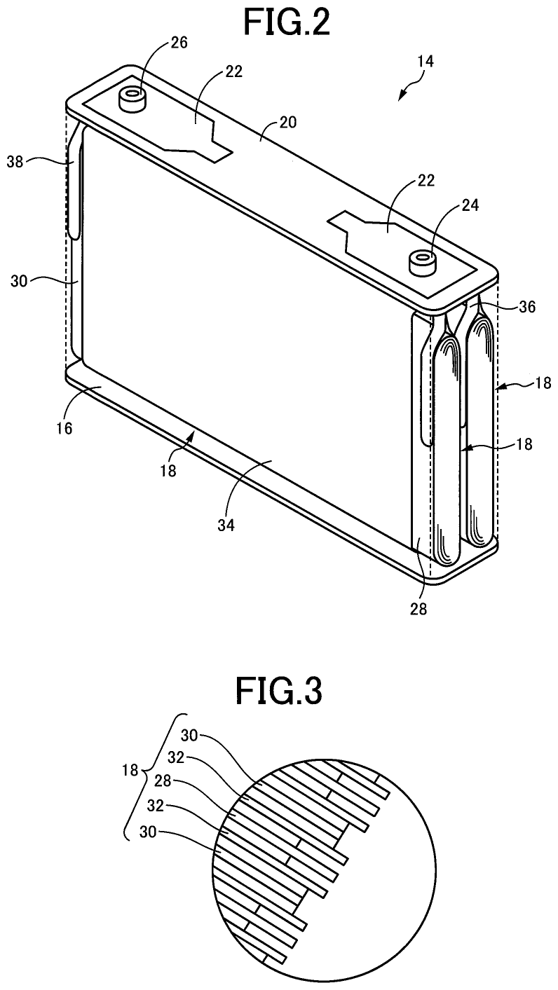

The battery cell 14 has a construction as shown in FIG. 2, for example. The battery cell 14 includes a box-shaped casing 16 made of metal such as aluminum, a laminated current collector 18 housed in the casing 16, and a cover plate 20 liquid-tightly closing a rectangular opening that opens in an upper end of the casing 16. The cover plate includes a pair of insulators 22 and a pair of external electrodes in the form of a positive external electrode 24 and a negative external electrode 26, such that the positive and negative external electrodes 24, 26 are supported by the respective insulators 22 in a penetrating state.

The laminated current collector 18 includes a strip-shaped positive-electrode current collector body 28, a strip-shaped negative-electrode current collector body 30 and a strip-shaped separator 32. The positive-electrode current collector body 28, the negative-electrode current collector body 30 and the separator 32 are wound in a flat shape in a state of being stacked on each other. The positive-electrode current collector body 28 is formed by applying or bonding an active material containing lithium oxide to a surface of an aluminum foil, for example. The negative-electrode current collector body 30 is formed by, for example, applying or bonding a conductive porous material such as graphite or carbon to a surface of a copper foil. The separator 32 is interposed between the positive-electrode current collector body 28 and the negative-electrode current collector body 30. The separator 32 is an insulator that electrically insulates the positive electrode current collector body 28 and the negative-electrode current collector body 30 from each other. The separator 32 is made of a material that can be impregnated with an electrolyte, such as a woven fabric, a nonwoven fabric or a porous resin film.

The laminated current collector 18 is housed in the casing 16 while being wrapped by an insulating film 34. The positive external electrode 24 is connected to the positive-electrode current collector body 28 exposed to an outer periphery of the laminated current collector 18, via a positive-electrode current collector element 36 in the casing 16. The negative external electrode 26 is connected to the negative-electrode current collector body 30 exposed to the outer periphery of the laminated current collector 18, via a negative-electrode current collector element 38 in the casing 16.

Returning to FIG. 1, the battery module 12 includes bus bars 40 and a cooling pipe portion 42. Each of the bus bars 40 is made of a thick metal plate. Each of the bus bars 40 is connected to the positive external electrode 24 of a predetermined one of the battery cell 14 and the negative external electrode 26 of another one of the battery cells 14 which is adjacent to the predetermined one of the battery cells 14 by fastening bolts 44.

The cooling pipe portion 42 has a flat shape having a thickness dimension equal to or less than a height dimension of the bus bars 40, and is placed on upper surfaces of the plurality of battery cells 14 arranged to be adjacent to each other. The cooling pipe portion 42 has a width dimension substantially the same as a dimension of each of the battery cells 14 that is measured in a direction orthogonal to the predetermined direction 74 in which the plurality of battery cells 14 arranged, namely, in a longitudinal direction of each of the battery cells 14.

The cooling pipe portion 42 has a pipe wall 46 having an electrical insulation property. The pipe wall 46 is a flexible sheet made of a resin layer, or a laminated sheet including a plurality of kinds of layers that include the resin layer, for example. The cooling pipe portion 42 guides a cooling liquid 48 onto the battery module 12 for cooling the bus bars 40, and circulates the cooling liquid 48 there.

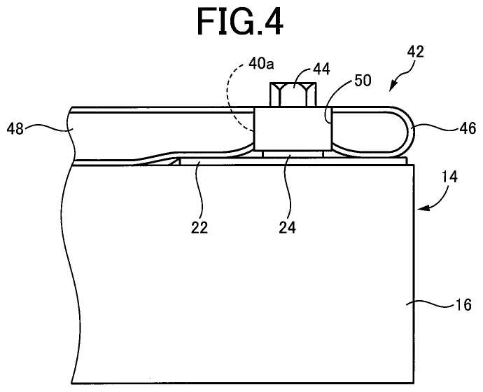

FIG. 4 is a cross sectional view for explaining a construction of the cooling pipe portion 42 on the battery module 12 in detail. A pair of rectangular through-holes 50 through which the bus bars 40 penetrate in the height direction are formed in the cooling pipe portion 42 for each of the bus bars 40. An inner peripheral edge of each of the pair of through holes 50 is sealed in a liquid-tight manner with respect to the side surfaces of the bus bars 40, by using, for example, an adhesive. The bus bars 40 are integrated with the cooling pipe portion 42.

The cooling pipe portion 42 covers side surfaces 40a of the bus bar 40, and the cooling liquid 48 is in thermal contact with the side surfaces 40a. The thermal contact means a contact state substantially equivalent to direct contact with respect to the side surfaces 40a of the bus bars 40, and includes a state in which the cooling liquid 48 is in contact with the side surfaces 40a of the bus bars 40 via a metallic thin film, a thin plastic film or the like. In the present embodiment, the cooling pipe portion 42 brings the cooling liquid 48 into direct contact with the side surfaces 40a of the bus bars 40.

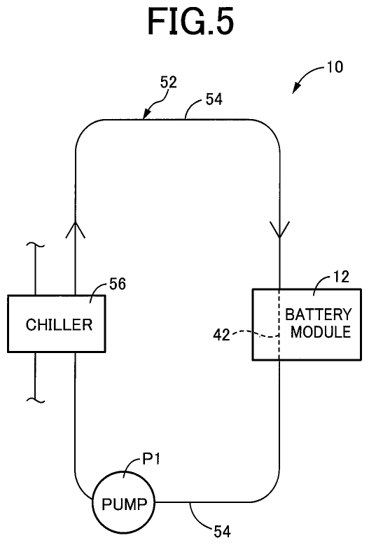

The cooling pipe portion 42 constitutes a part of a battery cooling circuit 54 in a battery thermal management device 52 shown in FIG. 5 and mounted on the vehicle. The battery thermal management device 52 is configured to execute a battery module cooling mode by a control device (not shown).

The battery thermal management device 52 includes the battery cooling circuit 54 for cooling the battery module 12, a chiller 56 and a pump P1.

The chiller 56 is a cooler configured to cool the cooling liquid 48 by heat-exchanging with a refrigerant of a heat pump circuit (not shown). The battery cooling circuit 54 is a closed circuit that connects between the chiller 56, the pump P1 and the cooling pipe portion 42 of the battery module 12 in series. In the battery module 12, the cooling liquid 48 is circulated in the cooling pipe portion 42 constituting a part of the battery cooling circuit 54 by the pump P1, so that the output from the battery module 12 is secured even in a high load region, and the temperature rise of the battery module 12 is suppressed even at the time of fast charge, and short-time charging is enabled.

As described above, according to the cooling device 10 according to the present embodiment, the cooling pipe portion 42 is configured to guide the cooling liquid 48 onto the battery module 12 such that at least a portion of each bus bar 40 and the cooling liquid 48 are in thermal contact with each other. As a result, a junction between a portion of the positive external electrode 24 or negative external electrode 26 connected to the bus bar 40 on an inner side of the battery cell 14 and the laminated current collector 18 is efficiently cooled, and thus high cooling efficiency is obtained.

According to the cooling device 10 according to the present embodiment, the cooling liquid 48 is composed of an oil or an ion-exchanged water having an electric conductivity reduced by an ion-exchange membrane. Since the oil or the ion-exchanged water is a liquid having high insulation, not only the electrical insulation between the bus bars 40 is secured, but also electric leakage is prevented even if liquid leakage occurs in the cooling pipe portion 42, so that safety is enhanced.

According to the cooling device 10 according to the present embodiment, the cooling pipe portion 42 covers a side surface of the bus bar 40 and brings the cooling liquid 48 into direct contact with the side surface of the bus bar 40. Thus, the cooling liquid 48 is brought into direct contact with the side surface of the bus bar 40, so that the junction between the portion of the positive external electrode 24 or negative external electrode 26 connected to the bus bar 40 on the inner side of the battery cell 14 and the laminated current collector 18 is efficiently cooled.

According to the cooling device 10 according to the present embodiment, the cooling pipe portion 42 is a flat pipe disposed around the bus bar 40. Therefore, the cooling pipe portion 42 is the flat pipe covering the side surface of the bus bar 40, and thus there is an aspect that a height of the battery module 12 is not increased.

According to the cooling device 10 according to the present embodiment, the cooling pipe portion 42 has the pipe wall 46 having an electrical insulation property. This maintains insulation between the bus bars 40 on the battery module 12, and enhances safety.

According to the cooling device 10 according to the present embodiment, the pipe wall 46 having the electrical insulation property is a flexible sheet made of a resin layer, or a laminated sheet including a plurality of kinds of layers that include the resin layer. Thus, the pipe wall 46 of the cooling pipe portion 42 has electrical insulation, and therefore not only the electrical insulation between the bus bars 42 is secured, but also the adhesion to the bus bars 42 is enhanced because of the flexibility.

According to the cooling device 10 according to the present embodiment, the cooling pipe portion 42 has a width dimension substantially the same as a dimension of each of the battery cells 14 that is measured in a direction orthogonal to the predetermined direction 74 in which the battery cells 14 arranged, and is disposed on a surface of the battery cells 14 on which the bus bars 40 are provided. Thus, the cooling pipe portion 42 is a flat pipe having the width dimension substantially the same as a width direction of the battery module 12, and therefore the battery module 12 is made compact in size.

According to the cooling device 10 according to the present embodiment, since the battery cooling circuit 54 is provided to cool the bus bars 40, by circulating the cooling liquid 48 between the cooling pipe portion 42 and the chiller (cooler) 56. Thus, the battery cooling circuit 54 circulates the cooling liquid 48 between the cooling pipe portion 42 and the chiller 56, thereby cooling the bus bars 40.

Although the embodiment of the present disclosure has been described in detail with reference to the drawings, the present disclosure is also applicable to other aspects.

For example, in the above-described embodiment, each of the bus bars 40 is connected in series to the positive external electrode 24 of a predetermined one of the battery cells 14 and the negative external electrode 26 of another one of the battery cells 14 adjacent to the predetermined one of the battery cells 14. However, each of the bus bars 40 may be connected to the positive external electrodes 24 of the adjacent battery cells 14 and may be connected to the negative external electrodes 26 of the adjacent battery cells 14 in parallel.

In the above-described embodiment, the cooling liquid 48 is brought into direct contact with portions of the side surfaces of the bus bars 40 that are covered by the cooling pipe portion 42. However, the cooling liquid 48 may be brought into direct contact with upper surfaces of the bus bars 40. In short, the cooling liquid 48 may be brought into direct or thermal contact with at least a part of each bus bar 40.

In the above-described embodiment, the gap between the inner peripheral edge of the through hole 50 formed in the pipe wall 46 and the bus bar 40 fitted into the through hole 50 is sealed by using an adhesive. However, other sealing structure such as an O-ring bonded to the inner peripheral edge of the through hole 50 may be employed.

The above description is merely one embodiment, and the present disclosure can be implemented in a mode in which various modifications and improvements are added based on the knowledge of those skilled in the art.

### NOMENCLATURE OF ELEMENTS

10: cooling device
12: battery module
14: battery cell
18: laminated current collector
24: positive external electrode
26: negative external electrode
40: bus bar
42: cooling pipe portion
46: pipe wall
48: cooling liquid
54: battery cooling circuit
56: chiller (cooler)

What is claimed is:

1. A cooling device for cooling a vehicle battery module that includes (i) a plurality of battery cells arranged in a predetermined direction and (ii) a bus bar electrically connecting between external electrodes of each adjacent two of the battery cells,
the cooling device comprising:
a cooling pipe portion configured to guide a cooling liquid onto the battery module such that at least a portion of the bus bar and the cooling liquid are in thermal contact with each other; and
a battery cooling circuit configured to cool the bus bar, by circulating the cooling liquid between the cooling pipe portion and a cooler.

2. The cooling device according to claim 1,
wherein the cooling liquid is composed of an oil or an ion-exchanged water having an electric conductivity reduced by an ion-exchange membrane.

3. The cooling device according to claim 1,
wherein the cooling pipe portion covers a side surface of the bus bar and brings the cooling liquid into direct contact with the side surface of the bus bar.

4. The cooling device according to claim 3,
wherein the cooling pipe portion is a flat pipe disposed around the bus bar.

5. The cooling device according to claim 1,
wherein the cooling pipe portion has a pipe wall having an electrical insulation property.

6. The cooling device according to claim 5,
wherein the pipe wall having the electrical insulation property is a flexible sheet made of a resin layer, or a laminated sheet including a plurality of kinds of layers that include the resin layer.

7. The cooling device according to claim 1,
wherein the cooling pipe portion has a width dimension substantially the same as a dimension of each of the battery cells that is measured in a direction orthogonal to the predetermined direction in which the battery cells arranged, and is disposed on a surface of the battery cells on which the bus bar is provided.
